(19) United States
(12) Patent Application Publication
(10) Pub. No.: US 2009/0009594 A1
(43) Pub. Date: Jan. 8, 2009

(54) Three-Dimensional Representation Apparatus

(76) Inventor: Kiyoyuki Kawai, Iwaki-city (JP)

Correspondence Address: ALPINE/BHGL, P.O. Box 10395, Chicago, IL, 60610, US

(21) Appl. No.: 12/163,059

(22) Filed: Jun. 27, 2008

(30) Foreign Application Priority Data
Jul. 6, 2007 (JP) 2007-178423

(51) Int. Cl. H04N 13/04

(52) U.S. Cl. 348/54; 348/E13.001

(57) ABSTRACT

Three-dimensional representation apparatus are disclosed. In one implementation, the three-dimensional representation apparatus includes a first two-dimensional picture forming device configured to form a first two-dimensional picture and a second two-dimensional picture forming device configured to form a second two-dimensional picture. The luminance of the first and second two-dimensional pictures may be individually adjusted. The first and second two-dimensional picture forming devices are positioned to be out of light paths for projecting the two-dimensional pictures formed by the other two-dimensional picture forming device. The three-dimensional representation apparatus may also include a focal distance adjustment optical element configured to adjust focal distances for each of the first and second two-dimensional pictures differently. A picture combining optical element of the three-dimensional representation apparatus is configured to combine the first and second two-dimensional pictures comprising different focal distances along the same optical axis. A display optical element of the three-dimensional representation apparatus is configured to display three-dimensional images by allowing the two-dimensional pictures combined by the picture combining optical element to be projected as virtual images at focusing positions displaced from each other along a sight line of a user.

### RELATED APPLICATIONS

The present application claims priority to Japanese Patent Application Serial Number 2007-178423, filed Jul. 6, 2007, the entirety of which is hereby incorporated by reference.

### FIELD OF THE INVENTION

The present invention relates to three-dimensional representation apparatuses, and in particular relates to a three-dimensional representation apparatus suitable for representing three-dimensional images.

### BACKGROUND OF THE INVENTION

Image displays may include a three-dimensional representation apparatus for three-dimensionally representing target images (hereinafter referred as to three-dimensional images). In such a three-dimensional representation apparatus, a number of apparatuses using a so-called anaglyph have been conventionally put to practical use, in which a user wearing dedicated eyeglasses can view three-dimensional images.

Three-dimensional representation apparatuses for viewing three-dimensional images without wearing dedicated eyeglasses (such as with the naked eye) have been developed. In one example, an apparatus provides the ability for a user to view three-dimensional images without wearing dedicated eyeglasses by displaying different images to a right eye of a user and a left eye of the user, where the different images are displayed to the right and left eyes of the user using a parallax barrier. However, in an apparatus using a parallax barrier, problems arise because of eye fatigue caused by viewing three-dimensional images for a long period of time.

Three-dimensional representation apparatus have also been developed in which three-dimensional images can be displayed by overlapping two pictures with the same content and different luminance, thereby displaying perspective images. Such a three-dimensional representation apparatus has an advantage in that eye fatigue is low even when a user views the three-dimensional image for a long period of time because the right eye and the left eye of the user view the same picture so that the intersecting point of sight lines of both the eyes substantially agrees with the display surface of the picture.

An example of the above-described three-dimensional representation apparatus for displaying images by overlapping the two pictures may include an apparatus shown in FIG. 4 in which two liquid crystal display panels 2 and 3 are arranged along a propagating direction of light emitted from a backlight 1 as a light source, for example.

In a three-dimensional representation apparatus 5 shown in FIG. 4, for forming images with the first liquid crystal display panel 2, the light emitted from the backlight 1 first passes through the first liquid crystal display panel 2; then, the light emitted from the backlight 1 passes through the second liquid crystal display panel 3 for forming images with the second liquid crystal display panel 3.

By passing through the first liquid crystal display panel 2, the quantity of the light emitted from the backlight 1 is reduced to one-tenth. By passing through the second liquid crystal display panel 3 after the first liquid crystal display panel 2, the quality of the light emitted from the backlight 1 is further reduced by an additional one-tenth to one-onehundreth. Thus, in the three-dimensional representation apparatus 5 shown in FIG. 4, because luminance is reduced by an additional one-tenth due to the use of a second liquid crystal display, it is difficult to efficiently achieve an increase in luminance of three-dimensional images without increasing the light quantity emitted from the backlight 1.

Another example of the above-described three-dimensional representation apparatus for displaying images by overlapping first and second pictures may include an apparatus (not shown) in which while the first picture is projected from the front face of a screen having a polarizing selective reflection function with a first projector to reflect it on the screen, the second picture with the same content and the luminance different from the first picture is projected from the back face of the screen with a second projector to pass through the screen. However, in such a three-dimensional representation apparatus using a projector, problems have arisen in that the apparatus is jumbo sized.

### SUMMARY OF THE INVENTION

Accordingly, the present invention has been made in view of such problems. It is an object of some implementations of the invention to provide a three-dimensional representation apparatus capable of increasing the luminance of three-dimensional images and the efficiency of displaying three-dimensional images, while reducing a size of the apparatus.

In one implementation, a three-dimensional representation apparatus includes a plurality of two-dimensional picture forming devices configured to form a plurality of two-dimensional pictures with luminance adjusted individually to each other, one two-dimensional picture forming device being arranged at a position out of light paths for projecting the two-dimensional pictures formed by the other two-dimensional picture forming devices along the light paths; a focal distance adjustment optical element configured to adjust focal distances differently to each other of the plurality of two-dimensional pictures formed by the plurality of two-dimensional picture forming devices, respectively; a picture combining optical element configured to combine the plurality of two-dimensional pictures, having the focal distances adjusted by the focal distance adjustment optical element differently to each other, together along the same optical axis; and a display optical element configured to display three-dimensional images by allowing the plurality of two-dimensional pictures combined by the picture combining optical element to be projected as a plurality of virtual images at focusing positions displaced from each other along a sight line of a user.

By such configurations, the plurality of two-dimensional picture forming devices are arranged at positions out of the light paths for projecting the two-dimensional images mutually formed by the other party, so that the light for projecting one of the two-dimensional images is prevented from being used for forming and projecting the other two-dimensional images, thereby efficiently displaying three-dimensional images with high luminance. Furthermore, the three-dimensional representation can be achieved with optical elements suitable for miniaturizing the apparatus, such as the focal distance adjustment optical element and the picture combining optical element, so that the three-dimensional representation apparatus can be miniaturized.

The display optical element may be a concave mirror. With such configurations, using the concave mirror as the display optical element, a plurality of the two-dimensional pictures combined by the picture combining optical element can be appropriately projected as virtual images, so that three-dimensional images can be appropriately displayed with simple and inexpensive configurations.

Furthermore, the focal distance adjustment optical element may be a lens. With such configurations, using the lens as the focal distance adjustment optical element, the focal distances of the plurality of two-dimensional pictures respectively formed by the plurality of two-dimensional image forming devices can be securely made differently from each other with simple configurations, thereby suitably displaying three-dimensional images as well as further miniaturizing the apparatus and reducing cost.

Furthermore, the two-dimensional image forming device may include a liquid crystal display panel. With such configurations, using the two-dimensional image forming device including the thin liquid crystal display panel, the apparatus can be further miniaturized.

Also, the two-dimensional image forming device may include a liquid crystal display panel of a transmission type or a semi-permeable reflection type and a light source for emitting light to the liquid crystal display panel. With such configurations, using the two-dimensional image forming device including the liquid crystal display panel and the light source, the luminance of the three-dimensional images can be further improved.

The three-dimensional representation apparatus may further include a spectroscopic optical element configured to split the light emitted from the light source for supplying the split light beams to the liquid crystal display panels different from each other.

With such configurations, by providing the spectroscopic optical element, the light emitted from one light source can be used for forming and projecting a plurality of two-dimensional pictures, so that a plurality of two-dimensional image forming devices having liquid crystal display panels can share the light source, thereby further miniaturizing the apparatus and reducing cost by reducing the number of the light sources.

Furthermore, the spectroscopic optical element also may be a half mirror. With such configurations, using the half mirror as the spectroscopic optical element, the apparatus can be further miniaturized.

The spectroscopic optical element also may be a polarization beam splitter. With such configurations, using the polarization beam splitter as the spectroscopic optical element, the apparatus can be further miniaturized.

Furthermore, the picture combining optical element may be a polarization beam splitter. With such configurations, using the polarization beam splitter as the picture combining optical element, a plurality of two-dimensional pictures can be preferably combined together, thereby further suitably displaying the three-dimensional images.

Furthermore, the picture combining optical element also may be a half mirror. With such configurations, using the half mirror as the picture combining optical element, the apparatus can be further miniaturized.

The three-dimensional representation apparatus may include two of the two-dimensional picture forming devices. With such configurations, by providing the two of the two-dimensional picture forming devices, the three-dimensional images composed of two of the two-dimensional pictures can be displayed, thereby further miniaturizing the apparatus and reducing cost.

Furthermore, the three-dimensional representation apparatus may be mounted on a vehicle. With such configurations, when the apparatus is incorporated in a head-up display on vehicle, the luminance and efficiency can be improved and the apparatus can be miniaturized.

Furthermore, the display optical element may be a concave mirror formed on a windshield of the vehicle. With such configurations, using the concave mirror formed on a windshield of the vehicle as the display optical element, the preexisting equipment can be used, thereby further reducing cost.

Also, part of the windshield where the concave mirror is formed may be a half mirror. With such configurations, by forming the half mirror on part of the windshield where the concave mirror is formed, while the three-dimensional images are suitably displayed, the visibility during driving is allowed, ensuring driving safety.

In the implementations described below, the luminance of three-dimensional images and the efficiency of three-dimensional representation can be increased as well as the apparatus can be miniaturized.

### BRIEF DESCRIPTION OF THE DRAWINGS

FIG. 1 is a diagram of one embodiment of a three-dimensional representation apparatus;

FIG. 2 is a diagram of another embodiment of a three-dimensional representation apparatus;

FIG. 3 is a diagram of yet another embodiment of a three-dimensional representation apparatus; and

FIG. 4 is a diagram illustrating an example of a conventional three-dimensional representation apparatus.

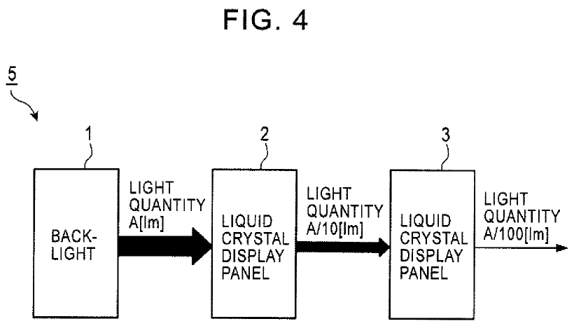

### DESCRIPTION OF THE PREFERRED EMBODIMENTS

### First Embodiment

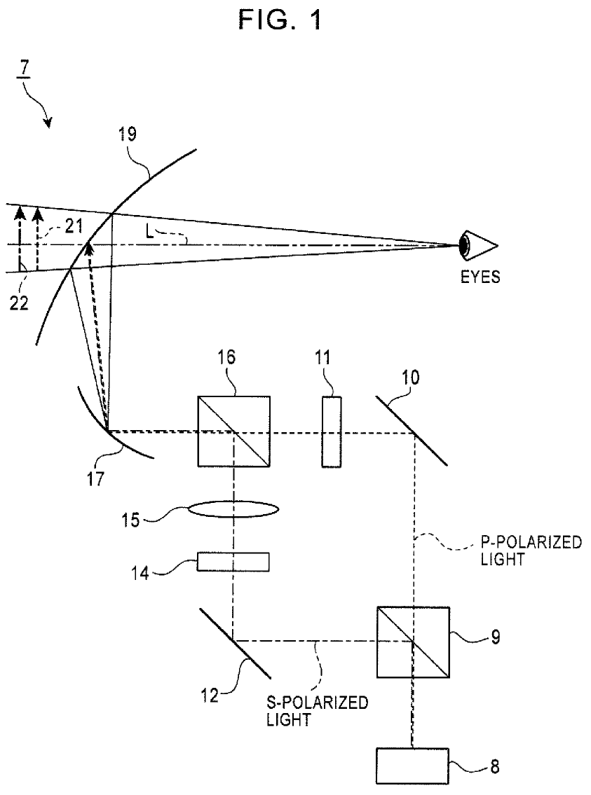

Implementations of a first embodiment of a three-dimensional representation apparatus are described below with reference to FIG. 1. As shown in FIG. 1, a three-dimensional representation apparatus 7 may include a light source 8 constituting part of a two-dimensional image forming apparatus. The light source 8 emits light including P-polarized linear light and S-polarized linear light, and may include a fluorescent lamp or a metal hydride lamp.

A first polarization beam splitter (PBS) (hereinafter referred to as a first polarization beam splitter 9) is arranged at a position on the light-emitting side of the light source 8 for serving as a spectroscopic optical element. The light emitted from the light source 8 enters the first beam splitter 9.

The first polarization beam splitter 9 allows the P-polarized light among the incident light from the light source 8 to pass through the first polarization beam splitter 9 in the same direction as the incidence direction from the light source 8, while allowing the S-polarized light to reflect perpendicularly to the incidence direction from the light source 8.

A first flat mirror 10 is arranged at a position on the passing-through side of the P-polarized light. The P-polarized light that has passed through the first beam splitter 9 enters the first flat mirror 10. Then, the P-polarized light incident from the first beam splitter 9 is completely reflected by the first flat mirror 10 in a direction that is perpendicular to the incidence direction of the P-polarized light.

A first transmission liquid crystal display panel (hereinafter referred to as a first liquid crystal display panel 11) is arranged at a position on the P-polarized light reflection side of the first flat mirror 10. The P-polarized light that is completely reflected by the first flat mirror 10 enters the first liquid crystal display panel 11.

The first liquid crystal display panel 11, although not shown, allows the incident light from the first flat mirror 10 to partially transmit the first liquid crystal display panel 11 by applying a liquid crystal drive voltage to a liquid crystal layer enclosed between panel substrates having a transparent electrode according to predetermined display information using the transparent electrode so as to change the liquid crystal molecular arrangement. The first liquid crystal display panel 11 forms two-dimensional images (hereinafter referred to as first two-dimensional images) according to the display information for emitting the two-dimensional images. The display information may include information about the luminance of the first two-dimensional images (luminance information). The luminance of the first two-dimensional images is regulated by adjusting the liquid crystal drive voltage on the basis of the luminance information.

A second flat mirror 12 is positioned on the S-polarized light reflection side of the first polarization beam splitter 9. The S-polarized light reflected by the first polarization beam splitter 9 enters the second flat mirror 12. The second flat mirror 12 completely reflects the S-polarized light incident from the first polarization beam splitter 9 in a direction that is perpendicular to the incidence direction of the P-polarized light.

A second transmission liquid crystal display panel constituting one two-dimensional image forming apparatus together with the light source 8 (hereinafter referred to as a second liquid crystal display panel 14) is positioned on the S-polarized light reflection side of the second flat mirror 12 and out of the light path for projecting the first two-dimensional images (in other words, the light path of the P-polarized light). The second flat mirror 12 completely reflects the S-polarized light into the second liquid crystal display panel 14.

The second liquid crystal display panel 14, having a structure similar to that of the first liquid crystal display panel 11, forms two-dimensional images with the same content as that of the first two-dimensional images (hereinafter referred to as second two-dimensional images) by allowing the S-polarized light to partially transmit the second liquid crystal display panel 14 on the basis of the same principle as that of the first liquid crystal display panel 11, for emitting the second two-dimensional images. The second liquid crystal display panel 14 also forms the second two-dimensional images while adjusting the luminance independently from the first liquid crystal display panel 11. The luminance of the second two-dimensional images may be higher than that of the first two-dimensional images, or the luminance of the second two-dimensional images may be lower than that of the first two-dimensional images. Alternatively, for example, only the luminance of a specific pixel in the second two-dimensional images may be higher than the luminance of the first two-dimensional images, or only the luminance of a specific pixel in the second two-dimensional images may be lower than the luminance of the first two-dimensional images.

As shown in FIG. 1, the position of the first liquid crystal display panel 11 is out of the light path for projecting the second two-dimensional images formed by the second liquid crystal display panel 14 (in other words, the light path of the S-polarized light).

At a position on the second two-dimensional images emitting side of the second liquid crystal display panel 14, that is, at a position on the transmission side of the S-polarized light, a focal distance adjustment lens 15 (a biconvex lens in FIG. 1) is arranged for serving as a focal distance adjustment optical element. The second two-dimensional images emitted from the second liquid crystal display panel 14 enter the focal distance adjustment lens 15.

With the focal distance adjustment lens 15, the focal distance of the second two-dimensional images is adjusted so that the focal distance of the first two-dimensional images and the focal distance of the second two-dimensional images are different at a projected position (a below-mentioned display convex mirror 19). By focusing the second two-dimensional images incident from the second liquid crystal display panel 14, adjusted second two-dimensional images are emitted.

A second polarization beam splitter (hereinafter referred to as a second polarization beam splitter 16), arranged for serving as an image combining optical element, is positioned on the first two-dimensional images emitting side of the first liquid crystal display panel 11 as well as on the second two-dimensional images emitting side of the focal distance adjustment lens 15, The first two-dimensional images emitted from the first liquid crystal display panel 11 and the second two-dimensional images emitted from the focal distance adjustment lens 15 enter the second polarization beam splitter 16 along incident directions that are perpendicular to each other, respectively.

Then, with the second polarization beam splitter 16, the first two-dimensional images including the P-polarized light, and incident from the first liquid crystal display panel 11, are transmitted in the same direction that the second two-dimensional images including the S-polarized light. and incident from the focal distance adjustment lens 15, are reflected in. Accordingly, the second polarization beam splitter 16 combines the first two-dimensional images with the second two-dimensional images along the same optical axis after making the focal distances differ from each other with the focal distance adjustment lens 15.

A reflection concave mirror 17 is positioned on the first two-dimensional images transmitting side of the second polarization beam splitter 16, as well as on the second two-dimensional images reflecting side. The first two-dimensional images combined with the second two-dimensional images by the second polarization beam splitter 16 enter the reflection concave mirror 17 along the same direction. The reflection concave mirror 17 reflects the combined first and second two-dimensional images incident from the second polarization beam splitter 16 in the same direction while maintaining the combined state along the same optical axis.

A display concave mirror 19 is positioned on the first and the second two-dimensional images reflecting side of the reflection concave mirror 17 for serving as a display optical element. The combined first and second two-dimensional images reflected by the reflection concave mirror 17 enter the display concave mirror 19.

On the display concave mirror 19, the combined first and second two-dimensional images incident from the reflection concave mirror 17 are projected as two virtual images at focusing positions displaced from each other along a sight line of a user, thereby displaying three-dimensional images. For helping you to understand this situation, a first virtual image 21 corresponding to the first two-dimensional images and a second virtual image 22 corresponding to the second two-dimensional images are shown in FIG. 1 to be focused at positions different from each other in a visual axial direction L of a user.

Functions of implementations of the first embodiment will now be described. In one implementation, while light is emitted from the light source 8, the liquid crystal drive voltage is applied to the liquid crystal layers of the respective first liquid crystal display panel 11 and second liquid crystal display panel 14 on the basis of display information. At this time, the luminance is regulated by individually adjusting the liquid crystal drive voltage applied to the respective first liquid crystal display panel 11 and second liquid crystal display panel 14.

The light emitted from the light source 8 enters the first polarization beam splitter 9 and is split into the P-polarized light and the S-polarized light. The P-polarized light and S-polarized light are then emitted from the first polarization beam splitter 9 in perpendicular directions.

The P-polarized light emitted from the first polarization beam splitter 9 is incident in the first flat mirror 10 so as to be totally reflected by the first flat mirror 10 in a direction that is perpendicular to the incident direction toward the first liquid crystal display panel 11; then, the P-polarized light passes through the first liquid crystal display panel 11 so as to be emitted from the first liquid crystal display panel 11 as the first two-dimensional images. The first two-dimensional images emitted from the first liquid crystal display panel 11 enter the second polarization beam splitter 16.

The S-polarized light emitted from the first polarization beam splitter 9 enters the second flat mirror 12 so as to be completely reflected by the second flat mirror 12 in a direction that is perpendicular to the incident direction toward the second liquid crystal display panel 14; then, the S-polarized light passes through the second liquid crystal display panel 14 so as to be emitted from the second liquid crystal display panel 14 as the second two-dimensional images. The second two-dimensional images emitted from the second liquid crystal display panel 14 enter the second polarization beam splitter 16 after being adjusted in focal distance with the focal distance adjustment lens 15.

The first and second two-dimensional images incident in the second polarization beam splitter 16 are emitted in the same direction by the transmission or the reflection in the second polarization beam splitter 16, and are combined together along the same optical axis. The combined first and second two-dimensional images emitted from the second polarization beam splitter 16 enter the reflection concave mirror 17 so as to be reflected in the same direction while being maintained in the combined state along the same optical axis. The combined first and second two-dimensional images reflected by the reflection concave mirror 17 enter the display concave mirror 19.

In the first and second two-dimensional images incident in the display concave mirror 19, since the focal distances are different from each other because of the adjustment using the focal distance adjustment lens 15, the first and second two-dimensional images are projected as the two virtual images 21 and 22 on the display concave mirror 19 at focusing positions displaced from each other along a sight line of a user. A user viewing the display concave mirror 19 having such virtual images 21 and 22 projected thereon in a predetermined visual axial direction L can recognize three-dimensional images from false illusion due to the difference in focal position and luminance between the first and second two-dimensional images.

In some implementations, the first liquid crystal display panel 11 and the second liquid crystal display panel 14 are arranged at positions out of the light path for projecting the two-dimensional images mutually formed by the other party, so that the light for projecting one of the two-dimensional images is prevented from being used for forming and projecting the other two-dimensional images, thereby efficiently displaying three-dimensional images with high luminance and without increasing the light quantity emitted from the light source 8.

In some implementations, the three-dimensional images are displayed with optical elements suitable for miniaturizing the apparatus, such as the polarization beam splitters 9 and 16, the flat mirrors 10 and 12, the focal distance adjustment lens 15, and the concave mirrors 17 and 19, as well as with the thin liquid crystal display panels 11 and 14, so that the apparatus can be miniaturized.

Furthermore, in some implementations, using the one light source 8, the two-party line system light path can be formed for both the first two-dimensional images and the second two-dimensional images, so that the number of the light sources 8 can be reduced, thereby further being miniaturized and reducing cost.

When the above-described three-dimensional representation apparatus is used for a head-up display on a vehicle, it is preferable to inexpensively display three-dimensional images using preexisting equipment, such as a vehicle windshield (the display concave mirror 19) or a room mirror, as a display optical element. When the windshield is used as the display concave mirror 19, it is preferable that part of the windshield serving as the display concave mirror 19 be a half mirror for allowing the visibility during driving. Furthermore, the light source 8, the first liquid crystal display panel 11, and the second liquid crystal display panel 14 may be driven by a battery on vehicle. The three-dimensional images displayed as the head-up display may include a instrument panel, such as a speed meter, and signs for prompting to turn left or right at a crossing during route guiding by navigation; these three-dimensional images may be viewed on top of the other on an actual road from a driver's seat.

The spectroscopic optical element may also include the half mirror instead of the above-mentioned first polarization beam splitter 9. Furthermore, the image combining optical element may also include the half mirror instead of the above-mentioned second polarization beam splitter 16. In these cases, although the loss in light quantity is rather increased, the three-dimensional images can be efficiently displayed with higher luminance than ever and the apparatus can be further miniaturized.

Furthermore, the liquid crystal display panel is not limited to a transmission type, and may alternatively be a type of semi-permeable reflection. Additionally, the display optical element is not limited to the display concave mirror 19, and may alternatively be a lens.

### Second Embodiment

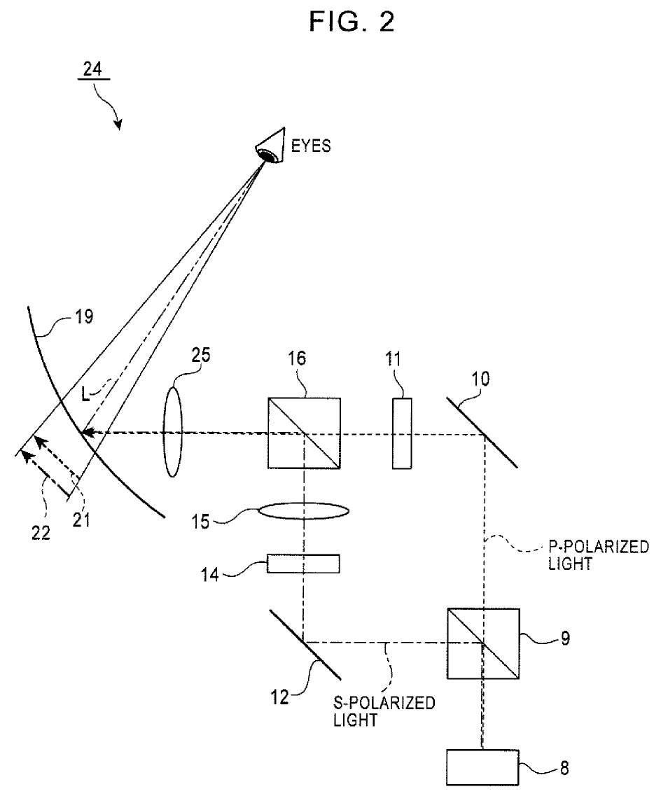

Implementations of a second embodiment of a three-dimensional representation apparatus are described with reference to FIG. 2, with an emphasis on differences with implementations of the first embodiment described above. Like reference characters designate like principal components common to the first embodiment, and the description will be made with reference to these.

As shown in FIG. 2, in some implementations of a three-dimensional representation apparatus 24, the configurations on the light path from the light source 8 to the second polarization beam splitter 16 are the same as some implementations of the three-dimensional representation apparatus 7 described above with respect to the first embodiment. However, as shown in FIG. 2, at a position on the first two-dimensional images transmission side as well as on the second two-dimensional images reflection side of the second polarization beam splitter 16, a collective lens 25 (a biconvex lens in FIG. 2) may be arranged instead of the reflection concave mirror 17 as shown in FIG. 1. Furthermore, as shown in FIG. 2, in some implementations the display concave mirror 19 may be positioned on the light emitting side of the collective lens 25 differently from the arrangement shown in FIG. 1.

In the three-dimensional representation apparatus 24 configured in such a manner, in some implementations as described above with respect to FIG. 1, when the first and second two-dimensional images combined together along the same light axis are emitted from the second polarization beam splitter 16, the first and second two-dimensional images are incident in the collective lens 25. The images enter the display concave mirror 19 after being condensed in the collective lens 25.

In some implementations, in the first and second two-dimensional images incident in the display concave mirror 19, since the focal distances are also different from each other because of the adjustment using the focal distance adjustment lens 15, the first and second two-dimensional images are projected as the two virtual images 21 and 22 on the display concave mirror 19 at focusing positions displaced from each other along a sight line of a user.

A user viewing the display concave mirror 19 having such virtual images 21 and 22 projected thereon in a predetermined visual axial direction L can recognize three-dimensional images with high luminance in the same way as in the first embodiment.

In implementations of the three-dimensional representation apparatus 24 described above, the luminance and efficiency can increased and the apparatus can be miniaturized from the same reason as that of the first embodiment.

### Third Embodiment

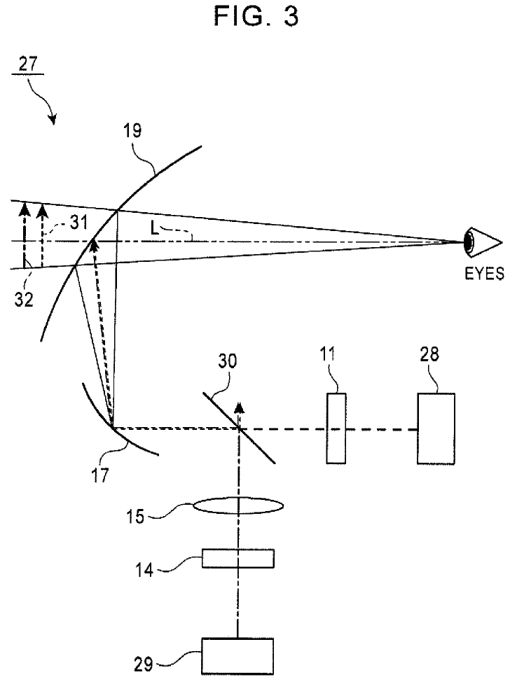

Implementations of a third embodiment of a three-dimensional representation apparatus are described below with reference to FIG. 3. Like reference characters designate like principal components common to the first embodiment, and the description will be made with reference to these.

As shown in FIG. 3, a three-dimensional representation apparatus 27 may include a first light source (hereinafter referred to as a first light source 28) for emitting light. The first liquid crystal display panel 11 is positioned on the light emitting side of the first light source 28. The light emitted from the first light source 28 enters the first liquid crystal display panel 11. However, in some implementations, since the light incident in the first liquid crystal display panel 11 is not divided based on the polarized component unlike implementations of the first embodiment, the light includes light other than the P-polarized light (the S-polarized light, for example).

The first liquid crystal display panel 11 forms the first two-dimensional images by allowing the incident light to transmit the first liquid crystal display panel 11 for emitting them with the adjusted luminance, from the same principle as that of the first embodiment.

In some implementations, the three-dimensional representation apparatus 27 may include a second light source (hereinafter referred to as a second light source 29) for emitting light perpendicularly to the light emitting direction from the first light source 28.

The second liquid crystal display 14 is positioned on the light emitting side of the second light source 29. The light emitted from the second light source 29 enters the second liquid crystal display panel 14. However, in some implementations, since the light incident in the second liquid crystal display panel 14 is not divided based on the polarized component unlike some implementations of the first embodiment, the light includes the light other than the S-polarized light (the P-polarized light, for example).

The second liquid crystal display panel 14 forms the second two-dimensional images by allowing the incident light to transmit the second liquid crystal display panel 14 for emitting them with the luminance adjusted separately from the first two-dimensional images, from the same principle as that of the first embodiment.

The focal distance adjustment lens 15 is positioned on the second two-dimensional images emitting side of the second liquid crystal display panel 14. The focal distance adjustment lens 15, in the same way as some implementations of the first embodiment, is to emit the second two-dimensional images incident from the second liquid crystal display panel 14 after adjusting their focal distance.

A half mirror 30, arranged for serving as an image combining optical element, is positioned on the first two-dimensional images emitting side of the first liquid crystal display panel 11 as well as on the second two-dimensional images emitting side of the focal distance adjustment lens 15. The first two-dimensional images emitted from the first liquid crystal display panel 11 and the second two-dimensional images emitted from the focal distance adjustment lens 15 enter the half mirror 30 along incident directions perpendicular to each other.

The half mirror 30 allows part of the first two-dimensional images incident from the first liquid crystal display panel 11 to transmit the half mirror 30 in the same direction as the incident direction while reflects part thereof perpendicularly to the incident direction. Also, the half mirror 30 allows part of the second two-dimensional images incident from the focal distance adjustment lens 15 to transmit the half mirror 30 in the same direction as the incident direction while reflects part thereof perpendicularly to the incident direction, that is, in the same direction as the first two-dimensional images transmitting direction through the half mirror 30. Accordingly, the part of the first two-dimensional images that have transmitted the half mirror 30 is combined with the part of the second two-dimensional images reflected by the half mirror 30 along the same optical axis.

As shown in FIG. 3, in some implementations, the first liquid crystal display panel 11 and the second liquid crystal display panel 14 are also arranged at positions out of the light path for projecting the two-dimensional images mutually formed by the other party.

At a position on the first two-dimensional images transmission side as well as on the second two-dimensional images reflection side of the half mirror 30, the reflection concave mirror 17 is arranged in the same way as implementations described above of the first embodiment. The first two-dimensional images and the second two-dimensional images combined together enter the reflection concave mirror 17 along the same direction.

The reflection concave mirror 17 reflects the combined first and second two-dimensional images incident from the half mirror 30 along the same direction while maintaining the combined state along the same optical axis.

At a position on the first and second two-dimensional images reflection side of the reflection concave mirror 17, similar to some of the implementations described above with respect to the first embodiment, the display concave mirror 19 is arranged for serving as the display optical element. The combined first and second two-dimensional images reflected by the reflection concave mirror 17 enter the display concave mirror 19.

In the first and second two-dimensional images incident in the display concave mirror 19, similar to some of the implementations described above with respect to the first embodiment, the focal distances are different from each other due to the focal distance adjustment by the focal distance adjustment lens 15, so that the first and second two-dimensional images, as shown in FIG. 3, are projected as two virtual images 31 and 32 on the display concave mirror 19 at focusing positions displaced from each other along a sight line L of a user.

A user viewing the display concave mirror 19 having such virtual images 31 and 32 projected thereon in a predetermined visual axial direction L can recognize three-dimensional images with high luminance in the same way as in the first embodiment.

In the three-dimensional representation apparatus 27, the luminance and efficiency can be increased and the apparatus can be miniaturized for the reasons discussed above with respect to some implementations of the first embodiment.

The present invention is not limited to the embodiments described above, and various modifications can be made if necessary. It is intended that the foregoing detailed description be regarded as illustrative rather than limiting, and that it is understood that it is the following claims, including all equivalents, which are intended to define the spirit and scope of this invention.

What is claimed is:

1. A three-dimensional representation apparatus comprising:
a plurality of two-dimensional picture forming devices configured to form a plurality of two-dimensional pictures, wherein the luminance of each two-dimensional picture of the plurality of two-dimensional pictures may be individually adjusted, and wherein each two-dimensional picture forming device is positioned out of light paths for projecting the two-dimensional pictures formed by the other two-dimensional picture forming devices of the plurality of two-dimensional forming devices;
a focal distance adjustment optical element configured to adjust focal distances differently for each two-dimensional picture of the plurality of two-dimensional pictures formed by the plurality of two-dimensional picture forming devices;
a picture combining optical element configured to combine the plurality of two-dimensional pictures comprising different focal distances together along the same optical axis; and
a display optical element configured to display three-dimensional images by allowing the plurality of two-dimensional pictures combined by the picture combining optical element to be projected as a plurality of virtual images at focusing positions displaced from each other along a sight line of a user.

2. The three-dimensional representation apparatus of claim 1, wherein the display optical element comprises a concave mirror.

3. The three-dimensional representation apparatus of claim 1, wherein the picture combining optical element comprises a half mirror.

4. The three-dimensional representation apparatus of claim 1, wherein the focal distance adjustment optical element comprises a lens.

5. The three-dimensional representation apparatus of claim 1, wherein each two-dimensional picture forming device of the plurality of two-dimensional picture forming devices comprises a liquid crystal display panel.

6. The three-dimensional representation apparatus of claim 5, further comprising a light source for emitting light to at least one liquid crystal display panel, wherein the liquid crystal display panels of the plurality of two-dimensional picture forming devices are of a transmission type or a semi-permeable reflection type.

7. The three-dimensional representation apparatus of claim 6, further comprising a spectroscopic optical element configured to split the light emitted from the light source and supply a different split light beam to each liquid crystal display of the plurality of two-dimensional picture forming devices.

8. The three-dimensional representation apparatus of claim 7, wherein the spectroscopic optical element comprises a half mirror.

9. The three-dimensional representation apparatus of claim 7, wherein the spectroscopic optical element comprises a polarization beam splitter.

10. The three-dimensional representation apparatus of claim 9, wherein the picture combining optical element comprises the polarization beam splitter.

11. A three-dimensional representation apparatus for use on vehicle, comprising:
A first two-dimensional picture forming device configured to form a first two-dimensional picture and a second two-dimensional picture forming device configured to form a second two-dimensional picture, wherein the luminance of the first and second two-dimensional pictures may be individually adjusted and wherein each of the first and second two-dimensional picture forming devices are positioned out of a light path of the other two-dimensional picture forming device;
a focal distance adjustment optical element configured to adjust the focal distances differently for each of the first and second two-dimensional pictures;
a picture combining optical element configured to combine the first and second two-dimensional pictures comprising different focal distances together along the same optical axis; and
a display optical element configured to display three-dimensional images by allowing the first and second two-dimensional pictures combined by the picture combining optical element to be projected as two virtual images at focusing positions displaced from each other along a sight line of a user.

12. The three-dimensional representation apparatus of claim 11, wherein the display optical element comprises a concave mirror formed on a windshield of the vehicle.

13. The three-dimensional representation apparatus of claim 12, wherein part of the windshield where the concave mirror is formed comprises a half mirror.

14. The three-dimensional representation apparatus of claim 11, wherein the first and second two-dimensional picture forming devices each comprise a liquid crystal display panel.
